(19) United States
(12) Patent Application Publication
(10) Pub. No.: US 2017/0197559 A1
(43) Pub. Date: Jul. 13, 2017

(54) CAR INTERIOR MATERIAL

(71) Applicant: SUMINOE TEXTILE CO., LTD., Osaka (JP)

(72) Inventors: Taro HATTORI, Osaka (JP); Nobutaka ONISHI, Osaka (JP); Osamu TOMITA, Nara (JP); Yoshihiko HATA, Shiga (JP)

(73) Assignee: SUMINOE TEXTILE CO., LTD., Osaka (JP)

(21) Appl. No.: 15/123,173

(22) PCT Filed: Mar. 4, 2014
(86) PCT No.: PCT/JP2014/055452

§ 371 Date: Sep. 1, 2016

(51) Int. Cl. B60R 13/02; B29C 43/20; B32B 27/32; B32B 27/12; B32B 27/20

(52) U.S. Cl. CPC B60R 13/02; B32B 27/12; B32B 27/20; B32B 27/32; B29C 43/203; B32B 2264/108; B32B 2605/003; B29K 2105/0085

(57) ABSTRACT

Provided is an automobile interior material capable of adequately maintaining a molded shape even when remolded (demolded) at a high temperature in thermoforming, and therefore capable of significantly shortening a molding time due to the capability of high temperature demolding. An automobile interior material 1 is provided with a fiber layer 2, and a resin layer 3 laminated on one surface of the fiber layer 2. The resin layer 3 is configured to contain a thermoplastic resin having a solidifying point of 82° C. to 190° C. measured by differential scanning calorimetry.

### TECHNICAL BACKGROUND

The present invention relates to an automobile interior material capable of being demolded at a high temperature in molding and thus capable of significantly shortening a molding time.

In this specification, the wording of “solidifying point measured by differential scanning calorimetry” means a crystallization temperature measured according to JIS K7121-1987 (transition temperature measuring method for plastics).

### BACKGROUND TECHNIQUE

As an automobile floor mat, it is required to be excellent in sound insulation to attain sufficient quietness in an automobile by blocking sounds, vibrations, etc., mainly from a floor side of an automobile.

As such an automobile floor mat having sound insulation, a structure in which a backing layer (backing resin layer) made of ethylene-vinyl acetate copolymer containing an inorganic filler in high concentration is provided on a rear surface of a carpet raw fabric is known (see Patent Document 1).

By containing the inorganic filler in the backing layer in high concentration as described above, the weight per unit area can be increased to thereby improve the sound insulation.

### PRIOR ART DOCUMENT

### Patent Document

[Patent Document 1] Japanese examined laid-open patent application publication No. S62-9010

### SUMMARY OF THE INVENTION

### Problems to be Solved by the Invention

By the way, an automobile interior material for use in an automobile floor mat, etc., is often used by being molded into a three-dimensional shape by, e.g., hot press-molding so that it can be arranged along a concavo-convex shape (it can be fitted to a concavo-convex shape) of an inner wall surface of, e.g., a floor surface in an automobile.

In the aforementioned prior art technique, however, ethylene-vinyl acetate copolymer is used as a resin constituting the backing resin layer. Therefore, when removed (demolded) at a high temperature after hot press-molding, the molded shape as a mat cannot be maintained. For this reason, it was required to perform demolding when it becomes a low temperature of about 20° C. to 30° C. after performing sufficient cooling after molding. Since sufficient cooling was required before demolding, there was a problem that it took a long period of time to perform molding.

The present invention was made in view of the aforementioned technical background, and aims to provide an automobile interior material capable of adequately maintaining a molded shape even when removed (demolded) at a high temperature in thermoforming and thus capable of demolding at a high temperature, which in turn can significantly shorten a molding time. The present invention also aims to provide a method of producing an automobile three-dimensionally molded interior material capable of significantly shortening a production time.

### Means for Solving the Problems

In order to attain the aforementioned objects, the present invention provides the following means.

[1] An automobile interior material including:

a fiber layer; and

a resin layer laminated on one surface of the fiber layer,

wherein the resin layer contains a thermoplastic resin having a solidifying point of 82° C. to 190° C. measured by differential scanning calorimetry.

[2] The automobile interior material as recited in the aforementioned item [1], wherein the resin layer contains an inorganic filler.

[3] The automobile interior material as recited in the aforementioned item [1] or [2], wherein the thermoplastic resin is a polyolefin-based resin.

[4] The automobile interior material as recited in the aforementioned item [1] or [2], wherein the thermoplastic resin is a copolymer containing at least ethylene as a copolymerization component.

[5] The automobile interior material as recited in the aforementioned item [1] or [2], wherein the thermoplastic resin is an ethylene-propylene copolymer.

[6] The automobile interior material as recited in any one of the aforementioned items [1] to [5], wherein a density of the thermoplastic resin is 0.80 g/cm³ to 1.50 g/cm³.

[7] The automobile interior material as recited in any one of the aforementioned items [4] to [6], wherein a content rate of the inorganic filler in the resin layer is 50 mass % to 90 mass %.

[8] The automobile interior material as recited in any one of the aforementioned items [1] to [7], wherein the resin layer contains carbon black.

[9] A method of producing an automobile three-dimensionally molded interior material, the method including:

a molding step of hot press-molding the interior material as recited in any one of the aforementioned items [1] to [8] in a temperature range higher than a solidifying point of the thermoplastic resin constituting a resin layer of the interior material by 1° C. to 200° C. using a molding die; and

a demolding step of removing the interior material when the interior material after molding is in a temperature range lower than the solidifying point of the thermoplastic resin by 1° C. to 120° C. from the molding die to obtain an automobile interior material molded into a three-dimensional shape.

### Effects of the Invention

In the invention as recited in the aforementioned item [1], the resin layer is configured to contain a thermoplastic resin having a solidifying point of 82° C. to 190° C. measured by differential scanning calorimetry (DSC). Therefore, the molded shape can be adequately maintained even when removed (demolded) at a high temperature (for example, 80° C.) in thermoforming, which in turn can significantly shorten the molding time because it becomes possible to perform demolding at a high temperature as described above (the cooling time can be shortened).

In the invention as recited in the aforementioned item [2], since the resin layer further contains an inorganic filler, it becomes possible to provide an automobile interior material having high stiffness, excellent dimensional stability, and sound insulation.

In the present invention as recited in the aforementioned item [3], since the thermoplastic resin is a polyolefin-based resin, it becomes possible to highly fill the inorganic filler, which can secure adequate sound insulation.

In the present invention as recited in the aforementioned item [4], since the thermoplastic resin is a copolymer containing at least ethylene as a copolymerization component, it becomes possible to highly fill the inorganic filler, which can secure adequate sound insulation.

In the present invention as recited in the aforementioned item [5], since the thermoplastic resin is an ethylene-propylene copolymer, it becomes possible to highly fill the inorganic filler, which can secure adequate sound insulation. Further, since the ethylene-propylene copolymer is used, the stiffness of the interior material can be improved.

In the present invention as recited in the aforementioned item [6], since the density of the thermoplastic resin is 0.80 g/cm³ to 1.50 g/cm³, it becomes possible to highly fill the inorganic filler, which can secure more adequate sound insulation.

In the invention as recited in the aforementioned item [7], since the content rate of the inorganic filler in the resin layer is within the range of 50 mass % to 90 mass % (highly filled) of the inorganic filler in the resin layer by employing the structure as recited in the aforementioned item [4], [5], or [6], an automobile interior material excellent in sound insulation can be provided. Further, by highly filling the inorganic filler to the range of 50 mass % to 90 mass %, the specific heat of the resin layer decreases, which can further shorten the cooling time and also can improve the stiffness of the interior material.

In the invention as recited in the aforementioned item [8], since the resin layer further contains carbon black, when heating is performed by far-infrared heating in thermoforming, the temperature of the resin layer, etc., can be raised efficiently (quickly), which in turn can further shorten the molding time.

In the invention as recited in the aforementioned item [9], since the hot press-molding is performed using the interior material as recited in any one of the aforementioned items [1] to [8], even when demolding is performed at a temperature range lower than the solidifying point of the thermoplastic resin by 1° C. to 120° C. (i.e., at a high temperature), the molded shape can be maintained adequately. Since demolding can be performed at a high temperature, the production time can be shortened significantly (i.e., excellent in productivity).

### BRIEF DESCRIPTION OF THE DRAWINGS

FIG. 1 is a cross-sectional view showing one embodiment of an automobile interior material according to the present invention.

FIG. 2 is a perspective view showing one example of an automobile three-dimensionally molded interior material produced by the production method of the present invention.

FIG. 3 is an explanatory view of a method of evaluating a molded shape retaining property.

### EMBODIMENTS FOR CARRYING OUT THE INVENTION

According to an automobile interior material 1 of the present invention, the automobile interior material includes a fiber layer 2, and a resin layer 3 laminated on one surface of the fiber layer 2. The resin layer 3 contains a thermoplastic resin having a solidifying point of 82° C. to 190° C. measured by differential scanning calorimetry.

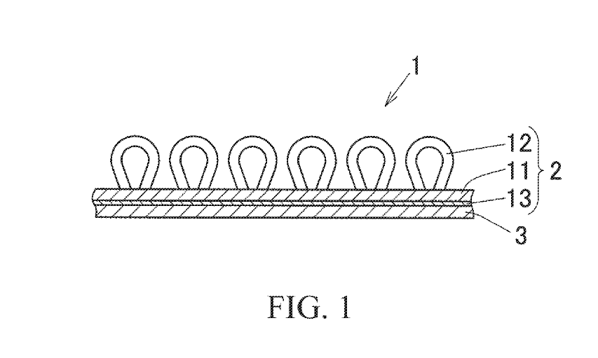

One embodiment of an automobile interior material 1 according to the present invention is shown in FIG. 1. This automobile interior material 1 is provided with a skin material layer 2 as a fiber layer, and a backing resin layer 3 laminated on a rear surface of the skin material layer. In this embodiment, the skin material layer 2 is configured such that piles 12 are implanted on an upper surface of a base fabric 11 and a precoat layer 13 is formed on a lower surface of the base fabric 11 by precoat treatment.

As the fiber layer 2, although not specifically limited, a fabric, such as, e.g., a woven fabric, a knitted fabric, a nonwoven fabric (e.g., needle-punched nonwoven) can be exemplified. The fiber layer 2 may be arranged on the front (upper) side of the interior material 1 as shown in the aforementioned embodiment, and also may be arranged on the rear surface side of the interior material 1. Alternatively, the fiber layer 2 may be used in a manner such that the front and rear surfaces cannot be distinguished, or may be arranged as an intermediate layer without being exposed to the front and rear surfaces.

The resin layer 3 contains a thermoplastic resin having a solidifying point of 82° C. to 190° C. measured by differential scanning calorimetry (DSC). Since it is configured to contain a thermoplastic resin having a solidifying point of 82° C. to 190° C. measured by differential scanning calorimetry, a desired molded shape can be maintained adequately even when removed (demolded) at a high temperature (for example, 80° C.) in molding. This makes it possible to perform demolding at a high temperature, which in turn can (shorten the cooling time) shorten the molding time significantly. If the solidifying point is less than 82° C., when remolding (demolding) is performed at a high temperature in molding, the molded shape cannot be maintained. Further, if the solidifying point exceeds 190° C., there occurs a problem that the design of the fiber layer 2 deteriorates. Among other things, it is preferable that the resin layer 3 is configured to contain a thermoplastic resin having a solidifying point of 89° C. to 120° C. measured by differential scanning calorimetry (DSC).

The resin layer 3 may be arranged on the front (upper) surface side of the interior material 1, and also may be arranged on the rear surface side of the interior material 1. Alternatively, the resin layer 3 may be used in a manner such that the front and rear surfaces cannot be distinguished, or may be arranged as an intermediate layer without being exposed to the front and rear surfaces.

It is preferable that the resin layer 3 is configured to further contain an inorganic filler. In this case, sound insulation can be given to the automobile interior material 1.

As the inorganic filler, although not specifically limited, for example, calcium carbonate, talc, barium sulfate, magnesium hydroxide, aluminum hydroxide, carbon black, alumina, silica, clay, etc., can be exemplified.

It is preferable that the content rate of the aforementioned “thermoplastic resin having a solidifying point of 82° C. to 190° C.” in the resin layer 3 is 10 mass % to 90 mass %, and that the content rate of the inorganic filler in the resin layer 3 is 10 mass % to 90 mass %. Among other things, it is more preferable that the content rate of the aforementioned “thermoplastic resin having a solidifying point of 82° C. to 190° C.” in the resin layer 3 is 10 mass % to 45 mass %. Further, it is more preferable that the content rate of the inorganic filler in the resin layer 3 is 55 mass % to 90 mass %.

As the thermoplastic resin, it is not specifically limited as long as the solidifying point measured by differential scanning calorimetry (DSC) is within a range of 82° C. to 190° C., and for example, a polyolefin-based resin having a solidifying point of 82° C. to 190° C., a polyester-based resin having a solidifying point of 82° C. to 190° C., etc., may be exemplified. As the polyolefin-based resin, although not specifically limited, for example, polyethylene, polypropylene, ethylene-based copolymer, propylene-based copolymer, etc., may be exemplified.

Among other things, as the thermoplastic resin, it is preferable to use an ethylene-propylene copolymer having a solidifying point of 82° C. to 190° C. In this case, it becomes possible to highly fill the inorganic filler (it becomes possible to highly fill the inorganic filler such that the content rate of the inorganic filler in the resin layer 3 becomes in the range of 50 mass % to 90 mass %). This can secure adequate sound insulation.

It is preferable that the ethylene content rate in the ethylene-propylene copolymer is within the range of 1 mass % to 50 mass %. In this case, the inorganic filler can be further highly filled.

It is preferable that the density of the thermoplastic resin having a solidifying point of 82° C. to 190° C. is 0.80 g/cm³ to 1.50 g/cm³. In this case, it becomes possible to highly fill the inorganic filler (it becomes possible to highly fill the inorganic filler such that the content rate of the inorganic filler in the resin layer 3 becomes within the range of 50 mass % to 90 mass %). As a result, adequate sound insulation can be secured. Among other things, it is more preferable that the density of the thermoplastic resin having a solidifying point of 82° C. to 190° C. is 0.85 g/cm³ to 0.93 g/cm³.

It is preferable that the melt flow rate (MFR) of the thermoplastic resin having a solidifying point of 82° C. to 190° C. is 1 g/10 min. to 100 g/10 min. In this case, it becomes possible to highly fill the inorganic filler (it becomes possible to highly fill the inorganic filler such that the content rate of the inorganic filler in the resin layer 3 becomes within the range of 50 mass % to 90 mass %). As a result, adequate sound insulation can be secured. Among other things, it is more preferable that the melt flow rate (MFR) of the thermoplastic resin is 2 g/10 min. to 50 g/10 min. Note that the MFR is a metal flow rate measured under conditions of a temperature of 190° C. and a load of 2.16 kg according to JIS 7210-1999.

It is preferable that the resin layer 3 is configured to contain carbon black. By containing carbon black, in thermoforming, since the temperature of the resin layer, etc., can be raised efficiently (quickly) by far-infrared heating, there is a merit that the molding time can be further shortened. It is preferable that the content rate of the carbon black in the resin layer 3 is within the range of 0.01 mass % to 0.5 mass %.

It is preferable that the weight per unit area of the resin layer 3 is set to 500 g/m² to 5,000 g/m². By being 500 g/m² or more, the sound insulation can be improved, while by being 5,000 g/m² or less, the lightweight property can be secured. Among other things, it is especially preferable that the weight per unit area of the resin layer 3 is set to 700 g/m² to 3,500 g/m².

It is preferable that the density of the resin layer 3 is 0.95 g/cm³ or more. In this case, the stiffness of the interior material 1 can be improved. Among other things, it is more preferable that the density of the resin layer 3 is set to fall within the range of 1.48 g/cm³ to 1.89 g/cm³.

Next, using the interior material having the aforementioned configuration, a method of producing an automobile three-dimensionally molded interior material 30 will be described.

Initially, a planar interior material 1 shown in FIG. 1 is hot-press molded in a temperature range higher than the solidifying point of the thermoplastic resin constituting the resin layer 3 of the interior material 1 by 1° C. to 200° C. using a molding die (Molding Step). By performing the hot press-molding in such a temperature range, it can be preferably molded into a desired molded shape.

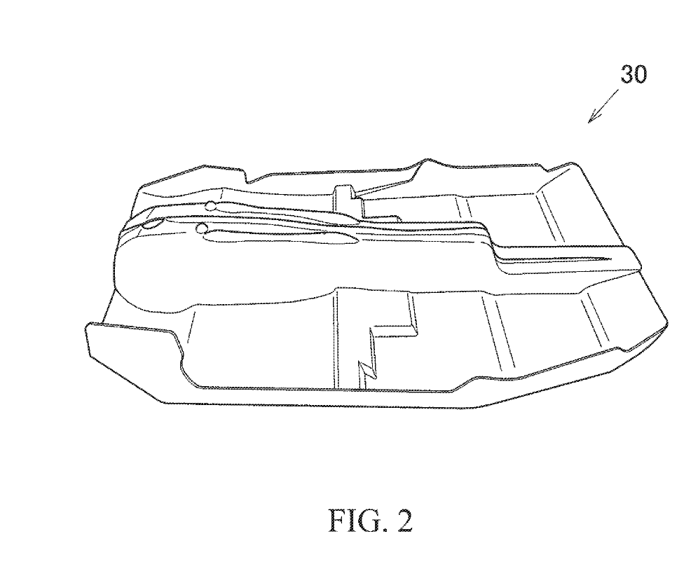

Next, the interior material after molding is cooled to lower the temperature of the interior material, and the interior material is removed (demolded) from the molding die when the temperature of the interior material is within the temperature range lower than the solidifying point of the thermoplastic resin by 1° C. to 120° C., to thereby obtain an automobile interior material 30 molded into a three-dimensional shape (Demolding Step). An example of the obtained automobile three-dimensionally molded interior material 30 is shown in FIG. 2.

According to this production method, since the resin layer 3 of the interior material is configured to contain a thermoplastic resin having a solidifying point of 82° C. to 190° C. measured by differential scanning calorimetry (DSC), even when molded in a temperature range lower than the solidifying point of the thermoplastic resin by 1° C. to 120° C. (i.e, at a high temperature), the molded shape can be maintained adequately. Since the demolding can be performed at a high temperature as described above, the production time can be shortened significantly, resulting in excellent productivity.

In the present invention, it is possible to employ a structure in which, other than the fiber layer 2 and the resin layer 3, one or more additional layers are further laminated. For example, it may be possible to employ a structure in which another layer such as a nonwoven fabric layer (for example, a nonwoven fabric layer having a weight per unit area of 15 g/m² to 3,000 g/m²) is further laminated on the rear surface of the resin layer 3.

### EXAMPLES

Next, concrete examples of the present invention will be described. However, it should be noted that the present invention is not specifically limited to these embodiments.

### Example 1

On a rear surface of a fabric in which piles (cut piles) 12 having a weight per unit area of 400 g/m² made of nylon fibers were tufted on a base fabric 11 made of a PET (polyethylene terephthalate) fiber nonwoven fabric having a weight per unit area of 100 g/m², an SBR latex was subjected to a precoat treatment to form a precoat layer 13 having a dry weight per unit area of 50 g/m². Thus, a skin material layer (fiber layer) 2 was obtained.

A resin composition (backing resin layer composition) obtained by mixing 30 parts by mass of ethylene-propylene copolymer (ethylene content rate: 9 mass %, solidifying point of the copolymer: 99° C.) having a density of 0.88 g/cm³ and 70 parts by mass of calcium carbonate (filler) was obtained.

Next, the resin composition was melt-extruded from an extruder at an application amount of 1,000 g/m² on the precoat layer 13 arranged on the rear surface side of the surface skin material 2, and then pressurized and cooled by nip rolls to form a backing resin layer 3. Thus, an automobile interior material 1 configured as shown in FIG. 1 was obtained.

### Example 2

An automobile interior material 1 configured as shown in FIG. 1 was obtained in the same manner as in Example 1 except that as the resin composition (backing resin layer composition), a resin composition obtained by mixing 30 parts by mass of ethylene-propylene copolymer (ethylene content rate: 11 mass %, solidifying point of the copolymer: 91° C.) having a density of 0.87 g/cm³ and 70 parts by mass of calcium carbonate (filler) was used.

### Example 3

An automobile interior material 1 configured as shown in FIG. 1 was obtained in the same manner as in Example 1 except that as the resin composition (backing resin layer composition), a resin composition obtained by mixing 35 parts by mass of ultralow density polyethylene resin (solidifying point: 86° C.) having a density of 0.90 g/cm³ and 65 parts by mass of calcium carbonate (filler) was used.

### Example 4

An automobile interior material 1 configured as shown in FIG. 1 was obtained in the same manner as in Example 1 except that as the resin composition (backing resin layer composition), a resin composition obtained by mixing 40 parts by mass of linear low-density polyethylene resin (solidifying point: 118° C.) having a density of 0.92 g/cm³ and 60 parts by mass of calcium carbonate (filler) was used.

### Example 5

An automobile interior material 1 configured as shown in FIG. 1 was obtained in the same manner as in Example 1 except that as the resin composition (backing resin layer composition), a resin composition obtained by mixing 40 parts by mass of polypropylene resin (solidifying point: 154° C.) having a density of 0.91 g/cm³ and 60 parts by mass of calcium carbonate (filler) was used.

### Comparative Example 1

An automobile interior material was obtained in the same manner as in Example 1 except that as the resin composition (backing resin layer composition), a resin composition obtained by mixing 30 parts by mass of ultralow density polyethylene resin (solidifying point: 77° C.) having a density of 0.90 g/cm³ and 70 parts by mass of calcium carbonate (filler) was used.

### Comparative Example 2

An automobile interior material was obtained in the same manner as in Example 1 except that as the resin composition (backing resin layer composition), a resin composition obtained by mixing 40 parts by mass of ethylene-vinyl acetate copolymer resin (solidifying point: 56° C.) having a density of 0.94 g/cm³ and 60 parts by mass of calcium carbonate (filler) was used.

Note that the solidifying point (solidification temperature) of the resin constituting the backing resin layer composition is a crystallization temperature measured according to JIS K7121-1987 (transition temperature measurement method for plastics). A measurement sample was set to a differential scanning calorimetry device (product number: DSC6200) made by Seiko Instruments Inc., and the temperature was raised from 20° C. to 280° C. at a temperature raising rate of 10° C./min. Thereafter, the temperature was lowered from the 280° C. to 40° C. at a temperature lowering rate of 10° C./min. During the time, the DSC curve was measured, and the solidifying point (crystallization temperature) was obtained from the DSC curve. In cases where two or more exothermic peaks appear during the temperature lowering, the lowest temperature (temperature at which sufficient crystallization was made) is defined as a solidifying point (crystallization temperature).

The automobile interior materials obtained as described above were evaluated based on the following evaluation method. The results are shown in Table 1.

TABLE 1

| | | | | | | | Molded shape after | | | |
|---|---|---|---|---|---|---|---|---|---|---|
| | | | | | | | demolded | | | |
| | Backing resin layer | | | | | | Evaluation of | | Evaluation of | |
| | Solidification | | | | | | retainability | | shrinkage rate | |
| | point of | Composition | | Tensile | Tensile | | Sagging | | Shrinkage | |
| | thermoplastic | (mass %) | | strength | elongation | Moldability | distance | | rate | |
| | resin (° C.) | Resin | Filler | (MPa) | (%) | Evaluation | (mm) | Evaluation | (%) | Evaluation |
| Ex. 1 | 99 | 30 | 70 | 8.7 | 66 | ◯ | 2 | ⊚ | 0.25 | ⊚ |
| Ex. 2 | 91 | 30 | 70 | 5.7 | 153 | ◯ | 2 | ⊚ | 0.25 | ⊚ |
| Ex. 3 | 86 | 35 | 65 | 3.5 | 47 | ◯ | 6 | ◯ | 0.50 | ◯ |
| Ex. 4 | 118 | 40 | 60 | 3.0 | 60 | ◯ | 2 | ⊚ | 0.25 | ⊚ |
| Ex. 5 | 154 | 40 | 60 | 5.2 | 41 | ◯ | 2 | ⊚ | 0.25 | ⊚ |
| Com. Ex. 1 | 77 | 30 | 70 | 3.1 | 600 | ◯ | 20 | X | 1.25 | X |
| Com. Ex. 2 | 56 | 40 | 60 | 5.0 | 44 | ◯ | 36 | X | 1.50 | X |

### <Moldability Evaluation Method>

Each automobile interior material was hot-press molded at 170° C. into a predetermined molded shape to obtain an automobile three-dimensionally molded interior material. In the three-dimensionally molded interior materials, presence or absence of occurrence of exfoliation between the surface skin material layer 2 and the backing resin layer 3 was examined. Interior materials in which no exfoliation occurred were denoted as “∘”, and interior materials in which exfoliation occurred were denoted as “x”.

<Evaluation Method of Molded Shape Retainability after Demolding>

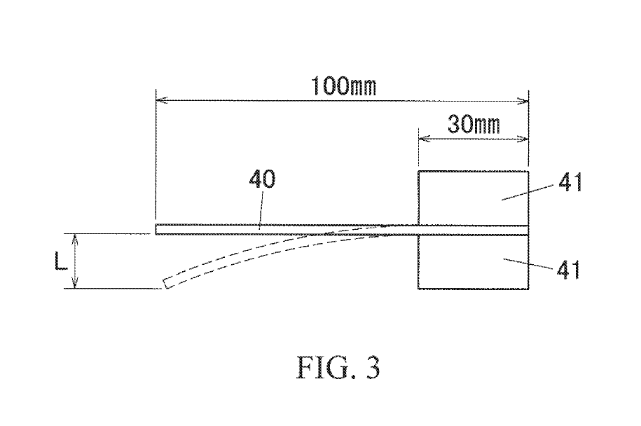

The resin composition (backing resin layer composition) used to produce each automobile interior material was heat-melted and filled in a form (length of 100 mm×width of 20 mm×depth of 1 mm). After cooled to normal temperature, a resin sheet (length of 100 mm×width of 20 mm×thickness of 1 mm) was removed from the form. After heating the obtained resin sheet in a constant temperature oven of 100° C. for 90 seconds, the resin sheet was removed and the longitudinal one end portion of the resin sheet 40 was immediately pinched and fixed by a pair of upper and lower fixing jigs 41 and 41. At this time, the tip end side (the other end portion) of the resin sheet 40 gradually sagged. After 60 seconds passed after the removal from the normal temperature oven, the sagging distance L (mm) of the tip end of the resin sheet 40 was measured (see FIG. 3). Based on the following decision criteria, the molded shape retainability after demolding was evaluated.

### (Decision Criteria)

“⊚” sagging distance was 5 mm or less
“◯” sagging distance exceeded 5 mm and less than 10 mm
“X” sagging distance was 10 mm or more

### <Evaluation Method of Shrinkage Rate of Automobile Three-Dimensionally Molded Interior Material>

After each automobile interior material was hot-press molded under the condition of 170° C. and 5 kg/cm², when the temperature was lowered to 80° C., the interior material was removed from the molding die. Thus, an automobile three-dimensionally molded interior material (200 mm long×200 mm wide) was obtained. Next, after the automobile three-dimensionally molded interior material was put in an oven of 100° C. for 30 min, the material was removed. After 30 minutes passed from the removal, at normal temperature, the vertical length and the horizontal length of the automobile three-dimensionally molded interior material were measured. The larger length was denoted as “length after the test” (mm), and the shrinkage rate was obtained from the following formula:

100×{(length after the test)−200}/200

The shrinkage rate was evaluated based on the following decision criteria.

### (Decision Criteria)

“⊚” Shrinkage rate was 0.25% or less
“◯” Shrinkage rate exceeded 0.25% and equal to or less than 0.5%
“X” Shrinkage rate exceeded 0.5%

### <Tensile Strength/Tensile Elongation Measurement Method>

According to the tensile test of JIS K6251-2010, under the conditions of a test piece width of 6 mm, a distance between marks of 25 mm, a tensile rate of 100 mm/min, the tensile strength (MPa) and the tensile elongation (%) were measured.

As apparent from the table, in the automobile interior material according to Examples 1 to 5 of the present invention, since the sagging distance of the tip end of the resin sheet 40 was small even at 100° C., the molded shape can be adequately maintained even after preforming the removal (demolding) at a high temperature in thermoforming.

On the other hand, in Comparative Examples 1 and 2 in which the solidifying point of the resin composition was smaller than the lower limit of the range defined by the present invention, the sagging distance of the tip end of the resin sheet 40 was large significantly when heated at 100° C. Thus, when removed (demolded) at a high temperature in thermoforming, a molded shape cannot be maintained.

### INDUSTRIAL APPLICABILITY

The automobile interior material according to the present invention is used (arranged) along an interior wall surface such as a floor surface of an automobile. For example, it may be used as an automobile floor mat by being arranged under a driver's or passenger's foot in an automobile compartment, or may be used as a loading platform mat or a luggage room mat of an automobile, a celling material of an automobile, a seat back of an automobile, an acoustic insulating material of a partition wall partitioning an engine room and an automobile interior, etc.

Further, the automobile interior material of the present invention can be used as a floor carpet (it normally cannot be removed) to be fixed to a floor surface of an automobile, and also can be used as an option mat (it normally can be removed) to be arranged on the floor carpet.

### DESCRIPTION OF SYMBOLS

1 automobile interior material
2 fiber layer (skin material layer, etc.)
3 resin layer (backing resin layer, etc.)
30 automobile three-dimensionally molded interior material

1. An automobile interior material comprising:
a fiber layer; and
a resin layer laminated on one surface of the fiber layer,
wherein the resin layer contains a thermoplastic resin having a solidifying point of 82° C. to 190° C. measured by differential scanning calorimetry.

2. The automobile interior material as recited in the claim 1, wherein the resin layer contains an inorganic filler.

3. The automobile interior material as recited in claim 1, wherein the thermoplastic resin is a polyolefin-based resin.

4. The automobile interior material as recited in claim 1, wherein the thermoplastic resin is a copolymer containing at least ethylene as a copolymerization component.

5. The automobile interior material as recited in claim 1, wherein the thermoplastic resin is an ethylene-propylene copolymer.

6. The automobile interior material as recited in claim 1, wherein a density of the thermoplastic resin is 0.80 g/cm³ to 1.50 g/cm³.

7. The automobile interior material as recited in claim 4, wherein a content rate of the inorganic filler in the resin layer is 50 mass % to 90 mass %.

8. The automobile interior material as recited in claim 1, wherein the resin layer contains carbon black.

9. A method of producing an automobile three-dimensionally molded interior material, the method comprising:
a molding step of hot press-molding the interior material as recited in claim 1 in a temperature range higher than a solidifying point of the thermoplastic resin constituting a resin layer of the interior material by 1° C. to 200° C. using a molding die; and
a demolding step of removing the interior material when the interior material after molding is in a temperature range lower than the solidifying point of the thermoplastic resin by 1° C. to 120° C. from the molding die to obtain an automobile interior material molded into a three-dimensional shape.
